(19) United States
(12) Patent Application Publication
(10) Pub. No.: US 2018/0040203 A1
(43) Pub. Date: Feb. 8, 2018

(54) GAMING CONSOLE FOR SIMULTANEOUSLY ENABLING ACTIVE AND PASSIVE PARTICIPATION

(71) Applicant: Competition Interactive LLC, Las Vegas, NV (US)

(72) Inventors: Keith Winters, Las Vegas, NV (US); Stephen Steelman, Los Angeles, CA (US); Matthew Mahaney, Henderson, NV (US); Paul Steelman, Las Vegas, NV (US); Keith Russell, Las Vegas, NV (US)

(21) Appl. No.: 15/667,608

(22) Filed: Aug. 2, 2017

Related U.S. Application Data
(60) Provisional application No. 62/370,665, filed on Aug. 3, 2016.

(51) Int. Cl. G07F 17/32; G07F 17/38

(52) U.S. Cl. CPC G07F 17/3288; G07F 17/3276; G07F 17/3262; G07F 17/3223; G07F 17/3225; G07F 17/38; G07F 17/3295; G07F 17/3211; G07F 17/3209

(57) ABSTRACT

This disclosure relates generally to gaming systems and, more specifically, to gaming systems for use in casinos. Even more specifically, this disclosure relates to systems that enable one or more players, who wager on the outcome of a game, to actively participate in the game and one or more other individuals, who do not actively participate in the game, to wager on the outcome of the game. A gaming station and a wagering station may be incorporated into the same gaming console, with the wagering station positioned behind a portion of the gaming station that is to be occupied by an active participant in a game. Each gaming console may include a public display monitor that may provide passive participants in the game and passersby with a wide view of the game. Gaming consoles may be grouped together such that their public display monitors may collectively provide different portions of such a wide view of the game.

### CROSS-REFERENCE TO RELATED APPLICATION

A claim for the benefit of priority to the Aug. 3, 2016 filing date of U.S. Provisional Patent Application No. 62/370,665, titled GAMING CONSOLE FOR SIMULTANEOUSLY ENABLING ACTIVE AND PASSIVE PARTICIPATION (“the '665 Provisional Application”) is hereby made pursuant to 35 U.S.C. §119(e). The entire disclosure of the '665 Provisional Application is hereby incorporated herein.

### TECHNICAL FIELD

This disclosure relates generally to gaming systems and, more specifically, to gaming systems for use in casinos. Even more specifically, this disclosure relates to systems that enable one or more players, who wager on the outcome of a game, to actively participate in the game and one or more other individuals, who do not actively participate in the game, to wager on the outcome of the game.

### SUMMARY

A gaming system according to this disclosure includes a central gaming unit, a plurality of gaming stations and a plurality of wagering stations. Each wagering station may also be referred to as a “back betting pod” or as “rear panel” of the gaming station. The gaming system may also include a public display system.

The central gaming unit of a gaming system according to this disclosure is capable of executing a game. The central gaming unit may also be capable of receiving wagers on the game. Wagers may be received from an active participant, who actively participates in game play. In addition, wagers may be received from a passive participant, who does not actively participate in game play.

In some embodiments, the central gaming unit comprises at least one processing element with which processing elements of one or more gaming stations communicate. The at least one processing element may include a game processing element, or a gaming processor, which executes the game, and/or a wager processing element, or a wager processor, which receives, processes, and, if appropriate, pays out on wagers. Such a central gaming unit may actually include a processing element of one of the gaming stations. Alternatively, the central gaming unit may be housed separately from the gaming stations (e.g., as a server, etc.), either in proximity to the gaming stations or remotely from the gaming stations.

The plurality of gaming stations communicate with the central gaming unit. Each gaming station of the plurality of gaming stations enables an active participant to place one or more wagers on the game and to actively participate in the game. Each gaming station of the plurality of gaming stations includes at least one monitor on which at least a portion of the game is displayed. The monitor of each gaming station may display a portion of the game from the perspective that an individual at the gaming station would have if he or she were actually participating in the competition or other event represented by the game; i.e., from that individual's virtual location within the game. In addition to the monitor, the gaming station may include one or more audio outputs (e.g., loud speakers, etc.), one or more tactile outputs (e.g., vibrating controls, motion seats, etc.) and one or more game play inputs (e.g., a steering wheel, pedals and one or more gear shifters; etc.). One or more wagering inputs of the gaming station, which may be made accessible to an individual at a side panel of the gaming station, may enable an active user at the gaming station to place one or more wagers.

The plurality of wagering stations also communicates with the central gaming unit. More specifically, each wagering station of the plurality of wagering stations may communicate (e.g., transmit, etc.) one or more wagers placed by one or more passive participants to the central gaming unit. In this regard, each wagering station may include at least one input elements that enables a passive participant to enter one or more wagers. Such an input element may comprise a monitor (e.g., a touch-sensitive display, etc.) and a card reader.

In some embodiments, a wagering station of the gaming system may be associated with a gaming station of the gaming system in a manner that will not interfere with an active participant's participation in the game. As an example, a wagering station may be located behind a compartment of a gaming station that is configured to be occupied by an active participant as he or she plays the game. The gaming system may even comprise an integral part of a gaming station.

In embodiments where the gaming system includes a public display system, the public display system may also communicate with the central gaming unit. The public display system may include one or more monitors that provides people who are in proximity to the gaming system, but who may not be actively participating in the game, with a view of the game. Thus, the public display system may provide passive participants, or those who have placed wagers on the game, with a view of the game so they can track the success of their wager(s). Casual observers can watch the game from the public display system for pure entertainment purposes, to determine whether or not they would like to place a wager on an active game or a future game or to determine whether they would like to actively participate in a future game. The public display system may also attract the attention of passersby to the game executed by the gaming system.

The public display system may display the game from a broader perspective, or a wider perspective, than the displays of any of the gaming stations of the gaming system. More specifically, the public display system may provide a view of the game from the vantage point of a spectator of a competition or other event represented by the game, rather than from the vantage point of a participant that event.

In another aspect, a gaming console is disclosed. A gaming console according to this disclosure includes a gaming station and a wagering station. The gaming console may also include a public display monitor, which may individually provide a public display of the competition or other event represented by the game or define part of a larger public display system of a gaming system that includes a plurality of the gaming consoles that have been grouped together. The gaming console, which may be included in a gaming system according to this disclosure, enables one or more individuals to wager on the outcome of a game (e.g., by way of wagering inputs on a side panel of the gaming station, etc.) and to actively participate in, or play, the game (e.g., by way of game play inputs, etc). The wagering station of the gaming console enables one or more other individuals who would like to place one or more wagers on the game, but who do not want to actively participate in the game, to place wagers without interfering with any active participant.

The gaming station of a gaming console includes a compartment, a monitor and one or more input devices. The compartment is capable of being occupied by an individual, such as an active participant in the game. In some embodiments, the compartment may include one or more accommodations for the individual (e.g., a seat, such as a seat that simulates a seat in a car, a seat in an airplane, a seat on a motorcycle, a saddle on a horse, etc.).

The monitor, which may be positioned in front of the compartment, enables an occupant of the compartment to view the game. The monitor may display a portion of the game from the perspective the occupant of the compartment would have if he or she were in the game, i.e., from that individual's virtual location within the game. In addition to the monitor, the gaming station may include one or more other output elements. Various embodiments of output elements of a gaming station of a gaming console include audio outputs (e.g., loud speakers, etc.), tactile outputs (e.g., vibrating controls, controls that provide a resistive force, motion seats, etc.) and/or other output devices that enhance the individual's experience as he or she plays the game.

The one or more input devices of the gaming station are accessible from the compartment, and may comprise part of the compartment. The input devices of the gaming station may include game play inputs, which may be referred to as “control devices,” that enable an individual to actively participate in a game, which are referred to as “control devices.” Various embodiments of control devices may include, but are not limited to, apparatuses that correspond to the type of occupant accommodations (e.g., a seat, etc.) provided in the compartment, and may include the accommodations (e.g., a moveable seat, etc.), as well as other controls (e.g., a steering wheel, pedals and, optionally, gauges for a car; a control yoke or stick, pedals, throttle controls and, optionally, gauges for an airplane; handlebars, hand controls, foot controls and, optionally, gauges; reins and stirrups for a horse; etc.).

The gaming station may also include one or more input devices that enable an individual who occupies the compartment to wager on one or more outcomes of a game in which the individual will actively participate, or play, as he or she occupies the compartment. Input devices that enable the individual to place one or more wagers may be referred to as “wagering devices.” The wagering devices may be carried by and made accessible to an individual at a side panel of the gaming station. A wagering device of the gaming station may enable the individual to bet that he or she will win the game and, optionally, to wager on one or more events and/or specific outcomes during the course of the game. Accordingly, a wagering device may enable the individual to enter his or her bet (e.g., with coins or cash, with a payment card, by electronic funds transfer (EFT), etc.) and, thus, enable the gaming station to receive the bet. In addition, a wagering device may enable the individual to select one or more events and/or outcomes from a plurality possible events and/or outcomes (e.g., by way of a touch-sensitive display, etc.) that may occur during the game and/or upon completion of the game and to place a wager on each selected event and/or outcome.

The monitor, any other output elements, each control device and each wagering device may communicate with a processing element that executes the game, or controls operation of the game. Such a processing element may be referred to as a “game processing element” or as a “gaming processor.” In some embodiments, the processing element may comprise a processing element of a separate central gaming unit with which the gaming console is capable of communicating, and optionally under whose control the gaming console operates. In other embodiments, the processing element may be part of the gaming console. Such a processing element may operate independently of outside apparatuses, in conjunction with or under control of a processing element of another gaming console, or in conjunction with or under control of a processing element of a central gaming unit.

The wagering station of a gaming console according to this disclosure enables individuals to place wagers on a game without actively participating in the game and without interfering with an active participant's abilities to place wagers on the game and play the game. A wagering station may be positioned behind the gaming station. More specifically, a wagering station may be positioned behind a location where an individual may occupy the gaming station, so as not to interfere with an active participant's participation in the game. The wagering station may be secured to the gaming station and, in some embodiments, the wagering station may be integrated into the gaming station.

Since the wagering station enables individuals to place wagers on a game, the wagering station includes one or more input devices, which are referred to herein as “wagering devices.” A wagering device of the wagering station may enable a passive participant in a game to bet that a certain player, or an active participant in the game, will win the game and/or to enable the passive participant to wager on one or more events and/or specific outcomes during the course of the game. Accordingly, a wagering device may enable the passive participant to enter his or her bet (e.g., with coins or cash, with a payment card, by electronic funds transfer (EFT), etc.) and, thus, enable the wagering station to receive the bet. In addition, a wagering device may enable the passive participant to select one or more events and/or specific outcomes from a plurality possible events and/or outcomes (e.g., by way of a touch-sensitive display, etc.) and to place a wager on each event and/or outcome he or she has selected.

Each wagering device of the wagering station may communicate with a wager processing element, or a wager processor, that receives all of the bets that are associated with a particular game and that manages payout on all of the winning bets that were placed on that particular game. The wager processor may be housed by the wagering station, the gaming station or any other part of the gaming console. Such a wager processor may operate independently of outside apparatuses, in conjunction with or under control of a processing element of another gaming console, or in conjunction with or under control of a processing element of a central gaming unit.

The wager processor may be dedicated to receiving bets and paying out on winning bets, in which case it communicates with a game processing element that executes the game to receive information pertinent to outcomes in the game that determine which payouts are to be made, as well as the amount of each payout. Alternatively, the same processing element may function as both a wager processor and a game processor.

In addition to the gaming station and the wagering station, a gaming console according to this disclosure may include a public display monitor. The public display monitor may be positioned and oriented to enable individuals who are not actively participating in the game, including any passive participants who have placed wagers on the game, as well as individuals who are not invested in any particular outcome(s) of the game, to view the game without interfering with any active participant's ability to play the game. In some embodiments, a public display monitor may be positioned and oriented such that neither the gaming station nor the wagering station of the console, or any occupant of the gaming station, will obstruct the view of casual observers from locations behind the gaming console. In some embodiments, the public display monitor may be positioned above the monitor of the gaming station.

The public display monitor displays images under the control of a processing element, such as a game processing element, that provide a view of the game from a broad perspective, such as from the perspective of a spectator of the game if the game were occurring in reality (e.g., from the grandstands at the side of a racecourse, etc.). In embodiments where two or more gaming consoles are grouped together, the public display monitors of the grouped gaming console may collectively display images, or a view of the game, that is to be seen by spectators, with each public display monitor providing a portion of the view (e.g., a left side, a middle portion, a right side, etc.).

Other aspects, as well as features and advantages of various aspects, of the disclosed subject matter will become apparent to those of ordinary skill in the art through consideration of the ensuing description, the accompanying drawings and the appended claims.

### BRIEF DESCRIPTION OF THE DRAWINGS

In the drawings:

FIGS. 1 and 1A schematically illustrate embodiments of a gaming console according to this disclosure;

FIG. 2 is a perspective view of an embodiment of a gaming console according to this disclosure;

FIG. 3 is a side view of the embodiment of gaming console shown in FIG. 2;

FIG. 4 is a top view of the embodiment of gaming console shown in FIG. 2;

FIG. 5 is a front view of the gaming console shown in FIG. 2;

FIG. 6 is a perspective view of an embodiment of a front portion of the embodiment of gaming console shown in FIG. 2, which includes a front portion of a gaming station and a public display monitor;

FIG. 6A provides an enlarged perspective view of an embodiment of some of the control devices at the front portion of the gaming console shown in FIG. 6;

FIG. 7 is a side view of the embodiment of the front portion of the gaming console shown in FIG. 6;

FIG. 8 is a top view of the embodiment of the front portion of the gaming console shown in FIG. 6;

FIG. 9 is a front view of the embodiment of the front portion of the gaming console shown in FIG. 6;

FIG. 10 is a perspective view of a backside of the embodiment of the front portion of the gaming console shown in FIG. 6;

FIG. 11 is a perspective view of an embodiment of active participant accommodations for an individual in the compartment of the gaming station of the gaming console shown in FIG. 2;

FIG. 12 is a first side view of the embodiment of the active participant accommodations shown in FIG. 11;

FIG. 13 is a second side view of the embodiment of the active participant accommodations shown in FIG. 11;

FIG. 14 is a top view of the embodiment of the active participant accommodations shown in FIG. 11;

FIG. 15 is a front view of the embodiment of the active participant accommodations shown in FIG. 11;

FIG. 16 is a perspective view of an embodiment of a side console of the gaming station of the gaming console shown in FIG. 2;

FIG. 17 is a front end view of the embodiment of side console shown in FIG. 16;

FIG. 18 is a top view of the embodiment of side console shown in FIG. 16;

FIG. 19 is an outside view of the embodiment of side console shown in FIG. 16;

FIG. 20 is a perspective view of the embodiment of side console shown in FIG. 16, depicting a pivot door of the side console in an open position to provide access to a receptacle within the side console;

FIG. 21 is a perspective view of an embodiment of the wagering station of the embodiment of gaming console shown in FIG. 2;

FIG. 22 is a side view of the embodiment of the wagering station shown in FIG. 21;

FIG. 23 is a top view of the embodiment of the wagering station shown in FIG. 21;

FIG. 24 is a front view of the embodiment of the wagering station shown in FIG. 21;

FIG. 25 is a rear perspective view of the embodiment of the wagering station shown in FIG. 21;

FIGS. 26 and 26A schematically depict embodiments of groups of gaming consoles;

FIG. 27 a front view of an embodiment of a group of the embodiment of gaming consoles shown in FIG. 1; and

FIG. 28 is a front view of another embodiment of a group of gaming consoles.

### DETAILED DESCRIPTION

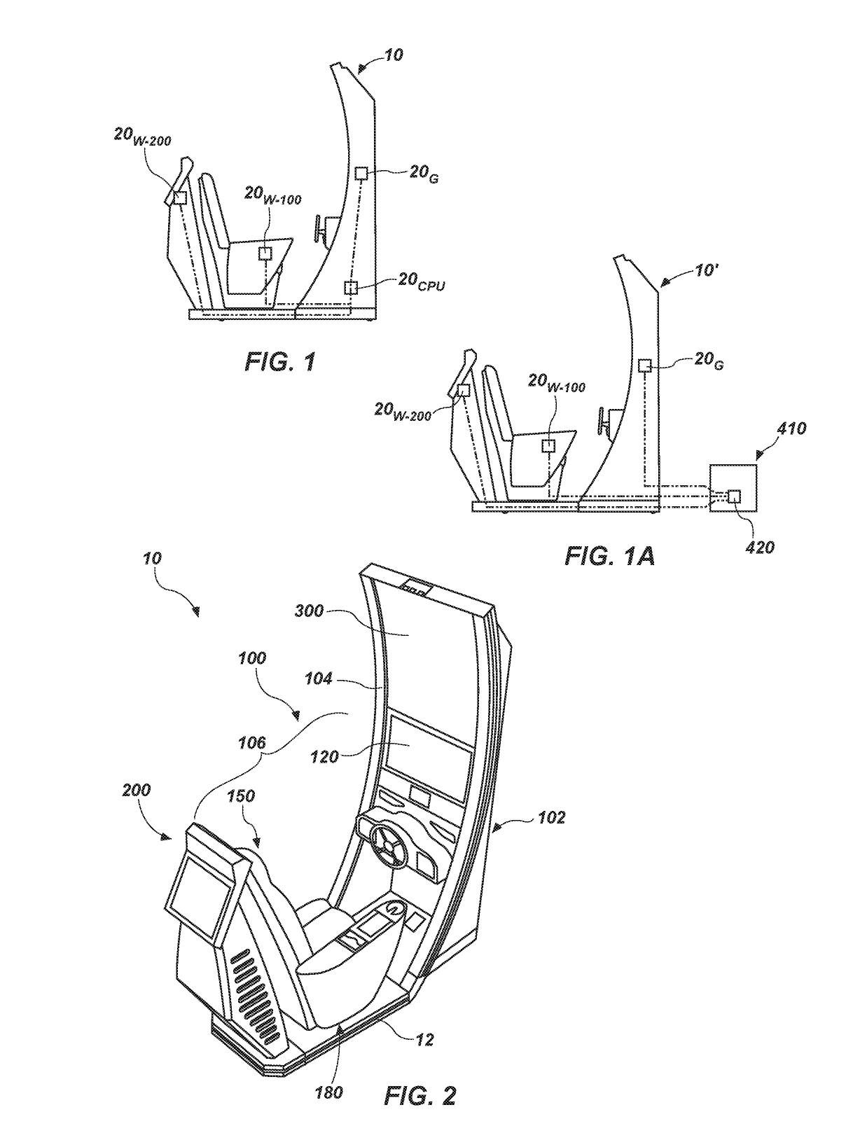

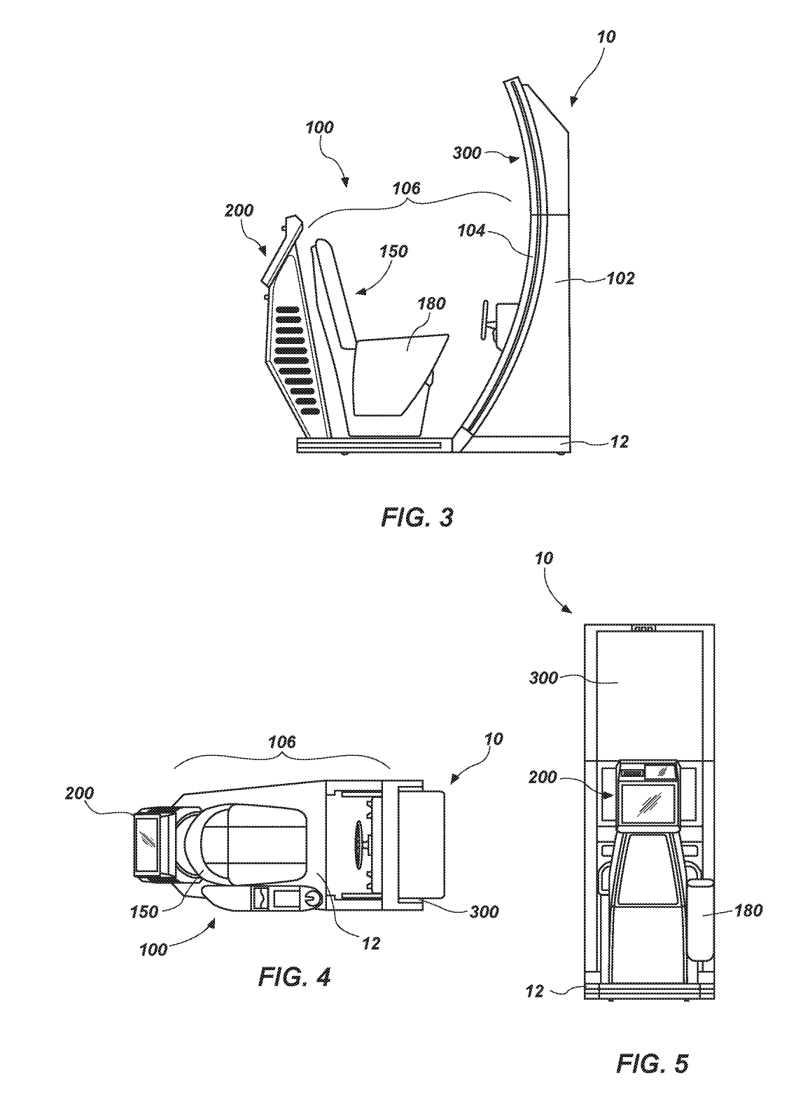

With reference to FIGS. 1-5, an embodiment of a gaming console 10 is illustrated. The gaming console 10 includes a gaming station 100 and a wagering station 200, with the gaming station 100 being located at a front of the gaming console 10 and the wagering station 200 being located at a rear of the gaming console 10. In addition to the gaming station 100 and the wagering station 200, the gaming console 10 may include a public display monitor 300. In the embodiment of gaming console 10 illustrated by FIGS. 2-5, the gaming station 100 and the wagering station 200 are carried by a base 12.

As shown in FIGS. 1 and 1A, a gaming console 10, 10′ also includes one or more processing elements 20 (e.g., microprocessors, graphics processors, microcontrollers, etc.). For example, the gaming console 10, 10′ may include a single processing element 20 (e.g., central processing unit 20_{CPU}, etc.) that executes a game, provides wager options, accepts wagers and determines and manages payouts on winning wagers. As another example, the gaming console 10, 10′ may include a gaming processor 20_{G} that is dedicated to execution of the game and one or more wager processors 20_{W} that are dedicated to providing wager options, accepting wagers and determining and managing payouts on winning wagers. In some embodiments, a first wager processor 20_{W-100} may be associated with wagering features of the gaming station 100 and second wager processor 20_{W-200} may be associated with wagering features of the wagering station 200. In such an embodiment, each wager processor 20_{W} may communicate with the gaming processor 20_{G}. Such communication may enable each wager processor 20_{W} to receive information about various events from the game, including the final outcome of the game, that correspond to events on which one or more individuals have placed wagers. The wager processor 20_{W} may then use that information to determine whether or not any payouts should be made on any of the wagers that were placed on the game and, if so, the amount of each payout.

Embodiments of gaming consoles 10, 10′ that include multiple processing elements 20 (e.g., a gaming processor 20_{G}, a wager processor 20_{W}, etc.) may also include a central processing unit 20_{CPU}. The central processing unit 20_{CPU} may coordinate operation of other processing elements 20 of the gaming console 10, 10′.

In embodiments where a gaming console 10, 10′ is capable of being grouped with and operating in concert with (e.g., enabling game play in the same game as) other gaming consoles 10, one or more processing elements 20 of a gaming console 10 (e.g., gaming processor 20_{G}, a wager processor 20_{W}, central processing element 20_{CPU}, etc.) may communicate with a processing element of another gaming console or, as shown in FIG. 1A, with a processing element 420 of a central gaming unit 410.

Although the game console 10 illustrated by FIGS. 2-5 is capable of use in a game that involves an automobile, such as a car racing game, it should be understood that gaming consoles that are capable of use in other types of games are also within the scopes of this disclosure and the appended claims. Without limitation, a game console 10 may be capable of use in a game that involves another type of vehicle, including, without limitation, an airplane, a motorcycle or a boat. Likewise, a game console may be capable of use in a game that involves riding a horse or another animal. Other types of game consoles that enable active participation in a game by one or more individuals (e.g., dancing games, running games, shooting games, etc.) are also within the scope of this disclosure.

The gaming station 100 of the gaming console 10 includes a front portion 102, which may be referred to as a “front panel,” which carries various game input devices 110 and a monitor 120 to enable an individual, or an “active participant,” to use the gaming console 10 to actively participate in a game. In addition, the front portion 102 of the gaming station 100 may carry the public display monitor 300 or bear at least a portion of the weight of a public display monitor 300. In the embodiment depicted by FIGS. 2-5, the public display monitor 300 is positioned above the monitor 120 of the gaming station 100. Such a position may enable individuals standing behind the gaming console 10 (i.e., behind the wagering station 200 of the gaming console 10) or to the side of the gaming console 10 to view the public display monitor 300 with little or no obstruction by any portion of the gaming console 10 (e.g., by the wagering station 200, etc.) or by an individual occupying the gaming station 100. The public display monitor 300 may be oriented at a somewhat downwardly facing angle (e.g., about 5 to about 30°; about 10°; about 15°; about 20°; about 25°; etc.), which may impart a front surface 104 of the front portion 102 of the gaming station 100 with a somewhat concave appearance. A somewhat downwardly facing angle may orient the public display monitor 300 toward eye level of adult individuals standing in proximity to (e.g., within about 20 feet of, within about 15 feet of, within about 10 feet of, etc.) the gaming console 10.

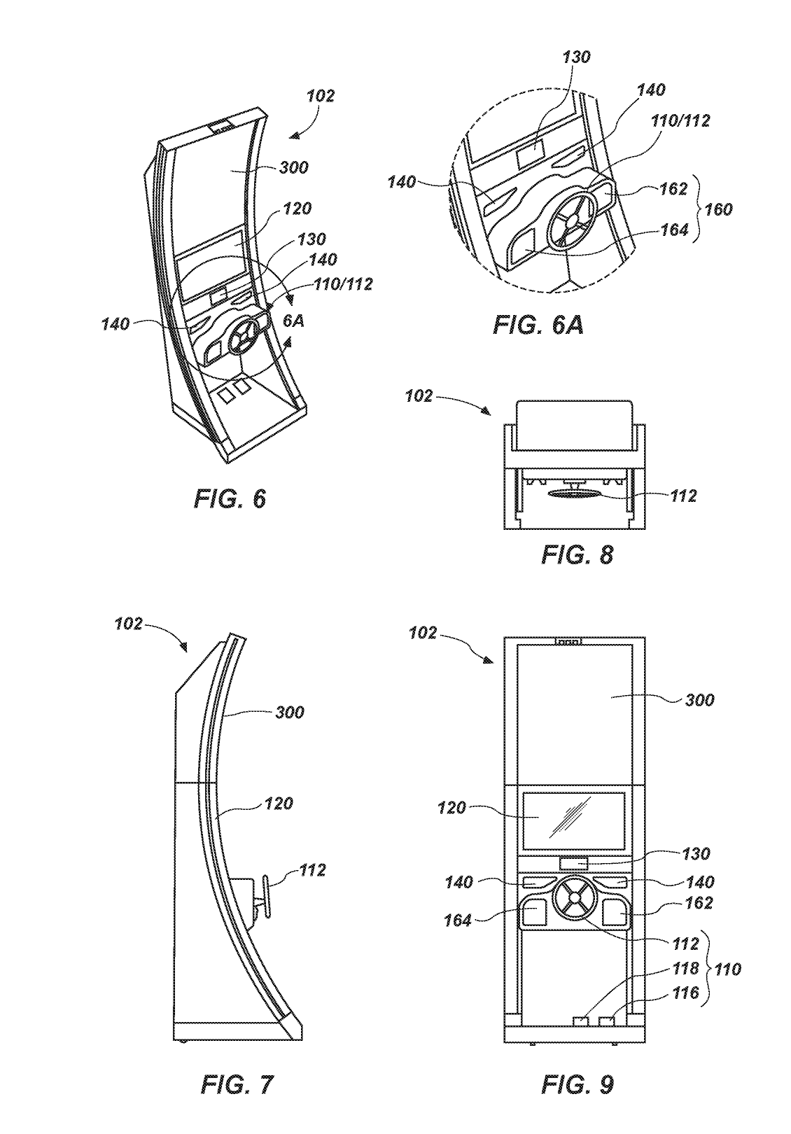

FIGS. 6-9 illustrate an embodiment of the front portion 102 of the gaming station 100 (FIGS. 2-5) of the gaming console 10 (FIGS. 2-5) in greater detail. The monitor 120 of the gaming station 100 may be positioned at a location that will make it readily visible to an individual as he or she uses the gaming console 10 to actively participate in a game. In embodiments where the gaming console 10 simulates a vehicle, such as a car, the monitor 120 may be positioned at a location where a windshield or windscreen would be located on the vehicle. The monitor 120, under control of a processing element 20 (e.g., a gaming processor 20_{G}, a central processing unit 20_{CPU}, etc.) (FIGS. 1 and 1A), which may be part of the gaming console 10, part of another gaming console with which the gaming console 10 communicates, of part of a central gaming unit that is distinct from the gaming console 10) displays an image. The image displayed by the monitor 120 may provide an active participant using the gaming console 10 with a view of the game from the perspective that he or she would have if he or she were in the game, i.e., from that individual's virtual location within the game.

As shown in FIGS. 6, 6A and 9, the game input devices 110 of an embodiment of gaming console 10 that simulates a car may include a steering wheel 112, optional paddle shifters (i.e., gear shifters) (not shown) on the steering wheel 112, an accelerator pedal 116 and a brake pedal 118. Each game input device 110 may communicate movement or other inputs by an individual to a processing element 20 (e.g., a gaming processor 20_{G}, a central processing unit 20_{CPU}, etc.) (FIG. 1) of the gaming console 10 and/or to a processing element (e.g., a central processing unit 20_{CPU}, etc.) (FIG. 1A) associated with the gaming console 10 and, thus, to provide the processing element 20 with suitable inputs from an active participant in a game. In addition, some embodiments of game input devices 110 may interact with tactile outputs (not shown), such as vibrating controls, controls that provide a resistive force, etc., that operate under control of the processing element 20 and which are capable of providing an active participant in a game, through one or more of the game input devices 110, with tactile feedback that corresponds to events occurring during game play.

In addition to the public display monitor 300, the monitor 120 and the game input devices 110, the front portion 102 of the gaming station 100 may carry a camera 130. The camera 130 may capture an image of an active participant as he or she plays the game. That image may be transmitted by the camera to a processing element 20, 420 (e.g., a gaming processor 20_{G}, a central processing unit 20_{CPU}, etc.) of the gaming console 10 (FIG. 1) or associated therewith (FIG. 1A) for a variety of purposes. As an example, an image of the active participant may be incorporated into a visual display of the game. As another example, the active participant's expressions, including his or her facial expressions, any gestures or the like, may be recorded as certain events happen during game play, at the conclusion of game play and/or immediately following the conclusion of game play. These images may then be made available to the active participant, optionally in conjunction with images of corresponding events from the game that were displayed to the active participant and/or to spectators during the game, as a record of the active participant's experience playing the game.

The front portion 102 of the gaming console 10 may also carry one or more audio output elements 140, such as the depicted loudspeakers.

FIGS. 11-15 provide different views of an embodiment of a seat 150, which, as shown in FIGS. 2-5, may be positioned at a back of the gaming station 110 or, more specifically, at a back of a compartment 106 of the gaming station 110, with the compartment 106 also including the front portion 102 of the gaming station 100. The seat 150 may rest upon and be secured to a base 12 of the gaming console 10. The seat 150 faces the front portion 102, and is configured to accommodate an individual in a manner that enables the individual to position himself or herself comfortably while interacting with or operating the game input devices 110. While the seat 150 is illustrated as representing the type of seat that would typically be found in a car, seats with other configurations are also within the scope of this disclosure (e.g., motorcycle seats, horse saddles, etc.), as are other types of accommodations that will enable an active participant in a game to comfortably occupy the compartment 106 as he or she interacts with or operates the game input devices 110 of the gaming station 100.

In some embodiments, the seat 150 or other accommodations may include or be associated with one or more output elements (not shown), which may be capable of providing an active participant in a game with sensations (e.g., vibration, movement, etc.) that he or she would have if the events occurring in the game were real. Since the outputs provided by such output elements correspond to game play, any output elements that are associated with the seat 150 or other accommodations operate under control of the same processing element 20 (FIGS. 1 and 1A) that executes the game.

The gaming station 100 of a gaming console 10 (FIGS. 2-5) according to this disclosure may include one or more wagering features 160 that enable an active participant in a game to place one or more wagers on the game. In the illustrated embodiment, the wagering features are carried by a side console, or a side panel, of the gaming station 100. With returned reference to FIG. 6A, in the illustrated embodiment of the gaming station 100, one of the wagering features 160 includes a card reader 162. The card reader 162 may be capable of interacting with a card (e.g., a bank card, an account card, etc.) associated with a financial account to enable an active participant to place a wager on one or more outcomes in a game, in a manner known in the art. Accordingly, the card reader 162 may communicate information about one or more wagers (e.g., a wager amount, an event to which a wager is attached, etc.) to a processing element 20 (e.g., a wager processor 20_{W}, a central processing unit 20_{CPU}, etc.) of the gaming console 10 (FIG. 1) or to a processing element 20 (FIG. 1A) associated with the gaming console 10.

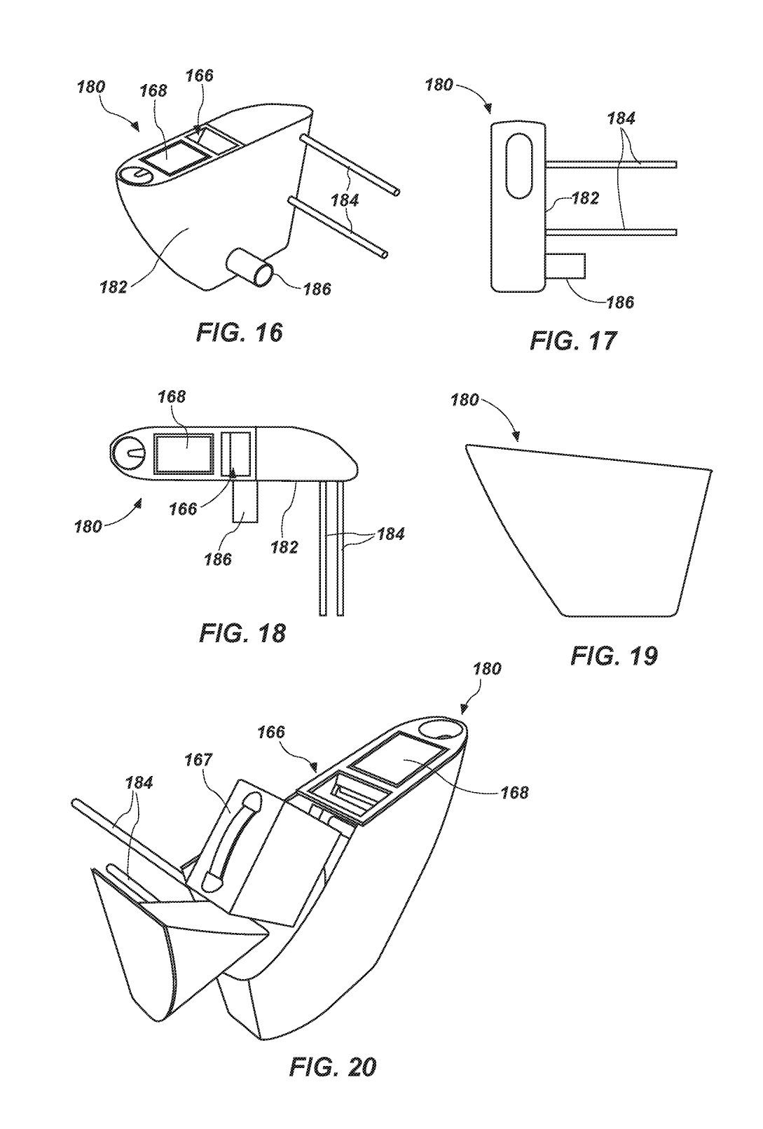

Turning to FIGS. 16-20, embodiments of other wagering features 160 that may be used with a gaming console 10 (FIGS. 2-5) according to this disclosure are illustrated. In particular, FIGS. 16-20 illustrate an embodiment of a side console 180 that may comprise part of the gaming station 100 (FIGS. 2-5) and, more specifically, part of the compartment 106 (FIGS. 2-5) of the gaming station 100. Such wagering features 160 may include a cash acceptor system 166 for receiving, counting and securely retaining currency, coins and/or tokens that are used to place a wager. A cash acceptor system 166 may communicate with a processing element 20 (e.g., a wager processor 20_{W}, a central processing unit 20_{CPU}, etc.) of the gaming console 10 (FIG. 1) or with a processing element 420 associated with the gaming console 10 (FIG. 1A). The embodiment of cash acceptor system 166 depicted by FIG. 20 includes a secure cash box 167 that may be removed from and replaced in a receptacle of the side console 180.

The gaming station 100 (FIGS. 2-5) may also include a betting screen 168. The betting screen 168 may, under control of a processing element 20 (e.g., a wager processor 20_{W}, a central processing unit 20_{CPU}, etc.) of or associated with the gaming console 10 (FIGS. 1 and 1A), display one or more events or outcomes on which an active participant in a game may place a wager. A touch sensitive aspect of the betting screen 168 may enable the active participant to select each event or outcome upon which he or she would like to wager, and to assign an amount to each wager. Thus, the betting screen 168 may act as a wager input device that communicates information about each wager to the appropriate processing element 20, 420.

With reference returned briefly to FIG. 6A, another possible wagering feature 160 of the embodiment of the gaming station 100 is a ticket printer 164. The ticket printer 164 may also communicate with the processing element 20, 420 (e.g., the wager processor 20_{W}, the central processing unit 20_{CPU}, etc.) that is part of or associated with the gaming console 10 (FIGS. 1 and 1A). Once a game is complete, the ticket printer 164 may print a receipt showing that any payout from one or more wagers on a game has been credited to an account associated with a card that has interacted with the card reader 162 or a ticket redeemable for such a payout in cash or any other suitable form of payment.

As depicted by FIGS. 2-5, the side console 180 may be secured to the base 12 of the gaming console 10, adjacent to a side of the seat 150 or any other accommodation for an active participant in a game. In addition, as illustrated by FIGS. 16-20, the side console 180 may be secured to the seat 150 or other accommodation. By way of example, one or more rods 184 and a post 186 may extend laterally from an inside surface 182 of the side console 180. Each rod 184 and post 186 may be received by and secured in place relative to corresponding receptacles 154, 156 (FIG. 13) in a frame 152 (FIG. 13) of the seat 150 or other accommodation.

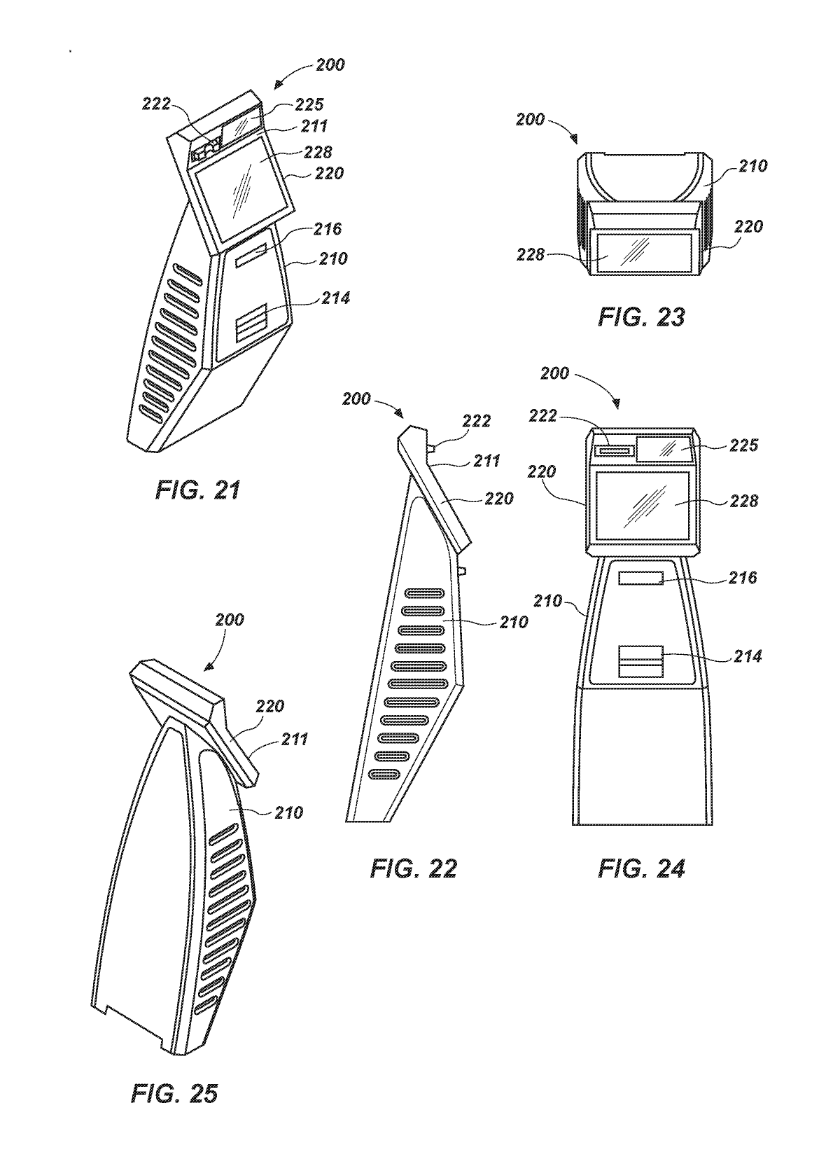

In the embodiment of gaming console 10 depicted by FIGS. 2-5, the wagering station 200 is positioned directly behind the compartment 106 of the gaming station 100 and, more specifically, directly behind accommodations for an active participant in a game, such as the illustrated seat 150. The wagering station 200 may also be referred to as a “back betting station” or as a “rear panel” of the gaming console 10. Referring now to FIGS. 21-25, the wagering station 200 may comprise a kiosk that enables a passive participant in a game to place a wager on one or more outcomes of the game without interfering with an active participant occupying the gaming station 100. A configuration of the wagering station 200 may enable the passive participant to walk up to the rear of the gaming console 10 and, while standing at the rear of the gaming console 10, place a wager on one or more outcomes of the game and, optionally, watch the game on the public display monitor 300 (FIGS. 2-5) while standing at the wagering station 200.

The wagering station 200 may include a base portion 210 and an upper portion 220. The base portion 210 of the wagering station 200 may be secured to a base 12 (FIGS. 2-5) of the gaming console 10 (FIGS. 2-5). In the illustrated embodiment, the base portion 210 of the wagering station 200 defines a height of the wagering station 200. The base portion 210 may carry one or more wagering features that enable a passive participant in a game to place a wager and/or receive a payout from a successful wager.

As illustrated by FIG. 24, one embodiment of wagering feature that may be carried by the base portion 210 of the wagering station is a cash acceptor system 216, which may receive, count and securely retain currency, coins and/or tokens that are used to place a wager. The cash acceptor system 216 may communicate with a processing element 20 (e.g., a wager processor 20_{W}, a central processing unit 20_{CPU}, etc.) of the gaming console 10 (FIG. 1) or with a processing element 20 associated with the gaming console 10 (FIG. 1A). The cash acceptor system 216 may include a secure cash box (not shown), which may be removed from and replaced in a receptacle of the base portion 210 of the wagering station 200.

Of course, other means for accepting funds to be wagered may also be included in a wagering station 200 of a gaming console according to this disclosure. As an example, the wagering station 200 may include a card reader 222. The card reader 222 may be capable of interacting with a card (e.g., a bank card, an account card, etc.) associated with a financial account in a manner known in the art to enable a passive participant to use the wagering station 200 to place a wager on one or more outcomes in a game. Accordingly, the card reader 222 may communicate information about one or more wagers (e.g., a wager amount, an event to which a wager is attached, etc.) to a processing element 20 (e.g., a wager processor 20_{W}, a central processing unit 20_{CPU}, etc.) (FIGS. 1 and 1A). As shown in FIG. 24, the card reader 222 may be carried by the upper portion 220 of the wagering station 200.

The upper portion 220 of the wagering station 200 may be located on top of the base portion 210. As illustrated by FIGS. 21, 22 and 25, the upper portion 220 of the wagering station 200 may include a surface 211 that is angled somewhat upward, so as to orient the surface 211 toward the face of an individual, such as a passive participant, while the individual stands at the wagering station 200. That surface 211 of the upper portion 220 may carry a back betting screen 228. The back betting screen 228, which operates under control of a processing element 20 (e.g., a wager processor 20_{W}, a central processing unit 20_{CPU}, etc.) (FIGS. 1 and 1A), may display one or more events or outcomes on which a passive participant in a game may place a wager. A touch sensitive aspect of the back betting screen 228 may enable the active participant to select each event or outcome upon which he or she would like to wager, and to assign an amount to each wager. Thus, the back betting screen 228 may act as a wager input device that communicates information about each wager to the appropriate processing element 20.

The wagering station 200 may also carry a ticket printer 214. In the illustrated embodiment of wagering station 200, the ticket printer 214 is carried by the base portion 210 of the wagering station 200. The ticket printer 214 may communicate with a processing element 20 (e.g., the wager processor 20_{W}, the central processing unit 20_{CPU}, etc.) that is part of or associated with the gaming console 10 (FIGS. 1 and 1A). Once a game is complete, the ticket printer 214 may print a ticket redeemable for such a payout in cash or any other suitable form of payment. Alternatively, the ticket printer 214 may print a receipt showing that any payout from one or more wagers on a game has been credited to an account associated with a card that has interacted with a card reader 222 of the wagering station 200.

With continued reference to FIG. 24, the upper portion 220 of the wagering station may also include a display 225, which may communicate with a processor 20 of or associated with the gaming console 10 (e.g., gaming processor 20_{G}, central processing unit 20_{CPU}, etc.) (FIGS. 1 and 1A) to enable an individual, such as a passive participant, to view the virtual location of each active participant (including individuals and any computer-generated participants) in the game (e.g., on a race course, on a field, etc.).

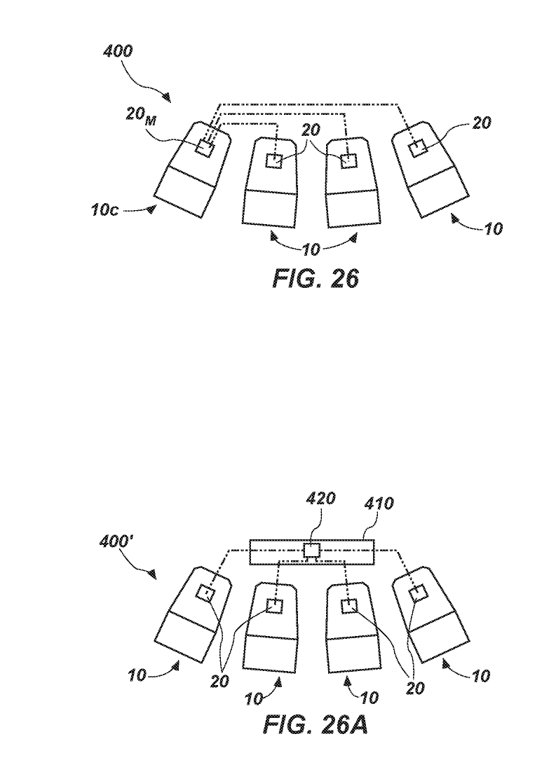

With reference shifted to FIGS. 26-28, various embodiments of gaming systems 400, 400′ according to this disclosure are depicted. In FIG. 26, an embodiment of a gaming system 400 that includes a plurality of gaming consoles 10 (FIG. 1) and a central gaming unit 410 is displayed. One or more processing elements 20 (e.g., gaming processors 20_{G}, wagering processors 20_{W}, central processing units 20_{CPU}—FIG. 1) of Each of the gaming consoles 10 may communicate with an appropriate processing element 20_{M} (e.g., gaming processors 20_{G}, wagering processors 20_{W}, central processing units 20_{CPU}—FIG. 1) of a master gaming console 10_{M}. That processing element 20_{M} of the master gaming console 10_{M} may control execution of the game (e.g., if the processing element 20_{M} is a gaming processor or a central processing unit) and/or may manage all of the wagering and payouts associated with the game (e.g., if the processing element 20_{M} is a wagering processor or a central processing unit).

FIG. 26A depicts an embodiment of a gaming system 400′ that includes a plurality of gaming consoles 10′ (FIG. 1A) and a central gaming unit 410. One or more processing elements 20 (e.g., gaming processors 20_{G}, wagering processors 20_{W}, central processing units 20_{CPU}—FIG. 1A) of each of the gaming consoles 10′ may communicate with one or more central processing units 420 of the central gaming unit 410. The central processing unit(s) 420 of the central gaming unit 400 control(s) execution of the game and may manage all of the wagering and payouts associated with the game.

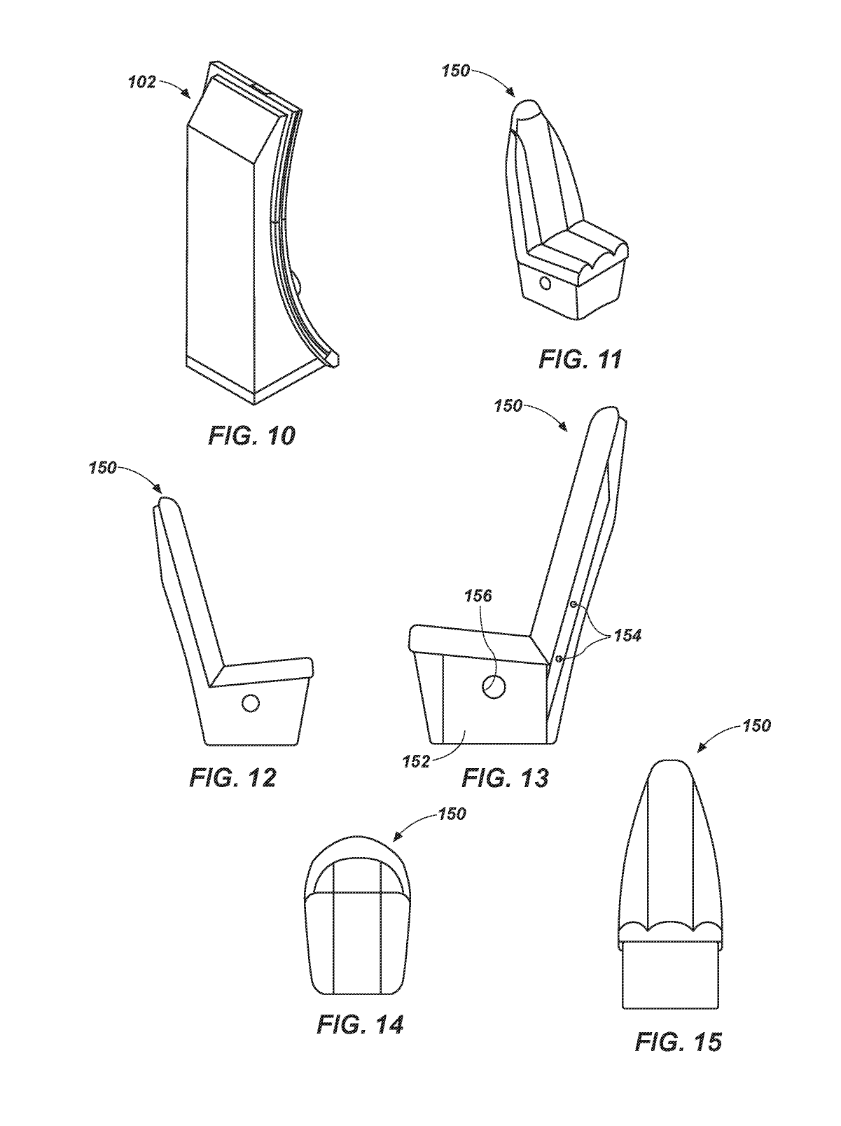

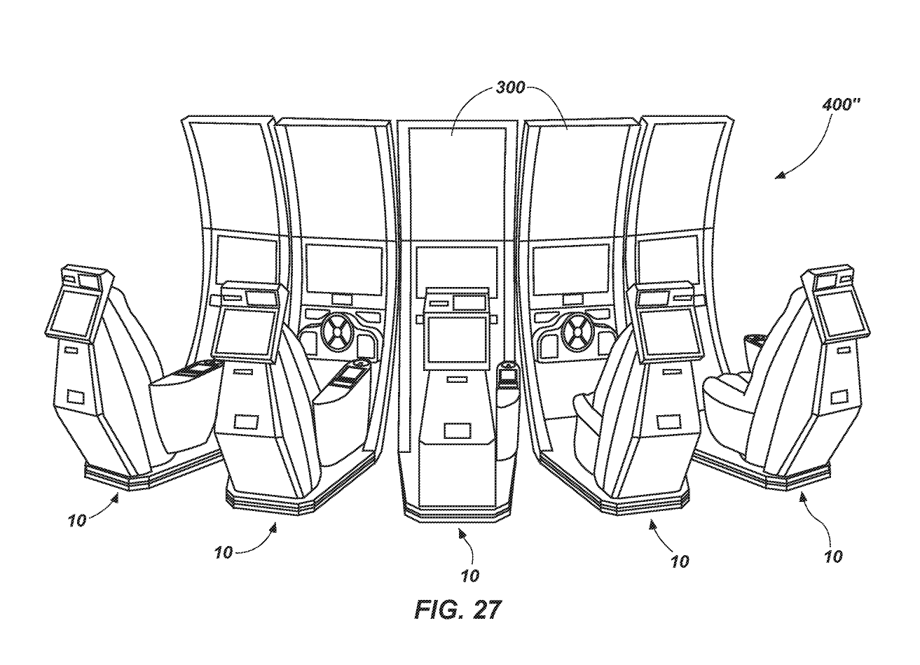

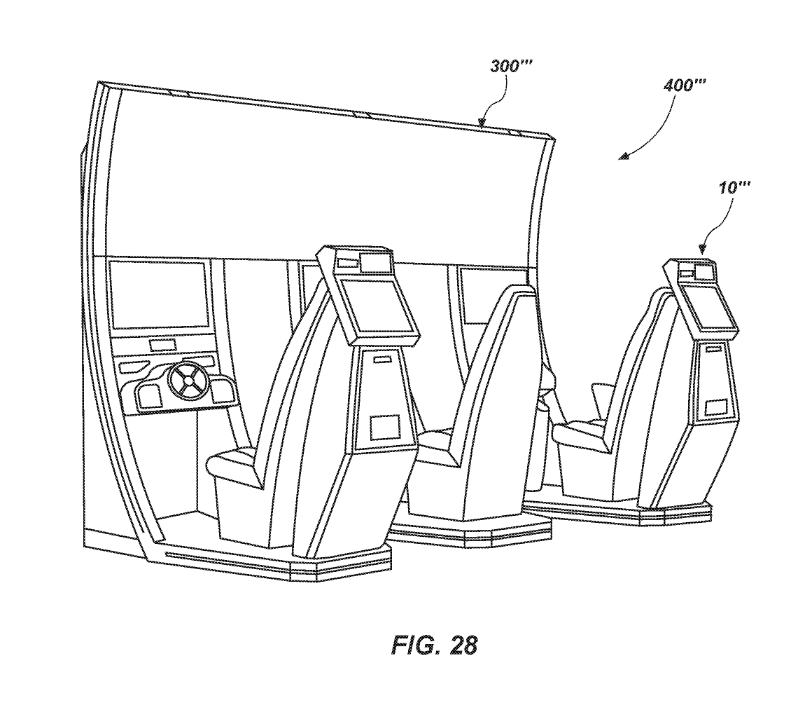

The embodiment of gaming system 400″ depicted by FIG. 27 includes a plurality of gaming consoles 10 of the type described in reference to FIGS. 2-25 (five (5) are shown). The gaming consoles 10 may be positioned next to one another in such a way that their public display screens 300 may show different parts of an elongated image. The gaming consoles 10 may be positioned at angles relative to one another to provide sufficient space for an individual walk between adjacent gaming consoles 10 and access the compartment 106 (FIGS. 2-5) of the gaming station 100 of one of the gaming consoles 10.

FIG. 28 depicts an embodiment of gaming system 400′″ in which a plurality of gaming consoles 10′″ (three (3) are shown) share a common public display screen 300′″. The gaming consoles are oriented parallel to one another, but spaced apart in a manner that will enable an individual to access the gaming station 100′″ of each of the gaming consoles 10′″. One or more of the gaming consoles 10′″ may lack a wagering station 200 (FIGS. 2-5).

Of course, other arrangements of gaming consoles that incorporate teachings of this disclosure are also within the scope of the disclosure.

Although the foregoing disclosure sets forth many specifics, these should not be construed as limiting the scope of any of the claims, but merely as providing illustrations of some embodiments and variations of elements and/or features of the disclosed subject matter. Other embodiments of the disclosed subject matter may be devised which do not depart from the spirit or scope of any of the claims. Features from different embodiments may be employed in combination. Accordingly, the scope of each claim is limited only by its plain language and the legal equivalents thereto.

What is claimed:

1. A gaming system, comprising:
a central gaming unit capable of:
executing a game capable of being played by at least one active participant and wagered on by at least one passive participant;
receiving a wager and enable active game play by the at least one active participant; and
receiving a wager from the at least one passive participant;
a plurality of gaming stations in communication with the central gaming unit, each gaming station of the plurality of gaming stations including:
a monitor for providing an output by the central gaming unit from a perspective unique to an active participant at that gaming station; and
at least one input device for communicating gaming inputs by the active participant at that gaming station to the central gaming unit;
a plurality of wagering stations in communication with the central gaming unit, each wagering station of the plurality of wagering stations being accessible by a passive participant without interfering with an occupant of any of the plurality of gaming stations, each wagering station of the plurality of wagering stations including:
at least one input for receiving a wager on the game and communicating the wager to the central gaming unit; and
a public display system in communication with the central gaming unit, the public display system being visible to individuals not occupying any of the plurality of gaming stations, including the at least one passive participant.

2. The gaming system of claim 1, wherein the central gaming unit is capable of executing a game comprising a multiplayer competitive game.

3. The gaming system of claim 1, wherein the multiplayer competitive game comprises a sports game.

4. The gaming system of claim 3, wherein the sports game comprises a racing game.

5. The gaming system of claim 2, wherein the multiplayer competitive game comprises a shooter game, a fighter game or a dancing game.

6. The gaming system of claim 1, wherein the plurality of gaming stations are grouped together.

7. The gaming system of claim 6, wherein the public display system is positioned above the plurality of gaming stations.

8. The gaming system of claim 1, wherein the monitor of each gaming station of the plurality of gaming stations is positioned at a front of a compartment to be occupied by an individual.

9. The gaming system of claim 8, wherein the compartment comprises a seat.

10. The gaming system of claim 9, wherein the compartment comprises a cockpit.

11. The gaming system of claim 8, wherein a wagering station of the plurality of wagering stations is located behind the compartment.

12. The gaming system of claim 11, wherein the wagering station is integrated into a corresponding gaming station.

13. The gaming system of claim 12, wherein the compartment of each gaming station comprises a seat.

14. The gaming system of claim 13, wherein the at least one input of the wagering station is located behind the seat.

15. The gaming system of claim 1, wherein the perspective unique to the active participant provided by the monitor of each gaming station of the plurality of gaming stations comprises a perspective representative of a view of an individual from a virtual location of the active participant in the game.

16. The gaming system of claim 15, wherein the central gaming unit is capable of displaying the game on the public display system from a different perspective than a perspective of the game displayed by the monitor of each gaming station.

17. The gaming system of claim 16, wherein the different perspective with which the central gaming unit causes the game to be displayed by the public display system comprises a wide field view from which an avatar corresponding to each contestant in the game is visible.

18. The gaming system of claim 16, wherein the different perspective with which the central gaming unit causes the game to be displayed by the public display system comprises a perspective of a location of a spectator of the game.

19. A gaming console, comprising:
a gaming station, including:
a compartment capable of being occupied by an occupant comprising an active participant in a game;
a monitor in front of the compartment for displaying the game from a perspective of the occupant of the compartment from a virtual location within the game;
at least one input for communicating gaming inputs by the occupant of the compartment; and
a wagering station behind the gaming station, the wagering station being accessible by an individual comprising a passive participant in the game without interfering with the occupant of the compartment of the gaming station, the wagering station including:
at least one input for receiving a wager on the game.

20. The gaming console of claim 19, further comprising:
a public display monitor positioned over the monitor and visible over the compartment of the gaming station and over an occupant of the compartment.

21. The gaming console of claim 20, wherein the public display monitor displays the game from a broad perspective, the broad perspective being different from the perspective of the occupant displayed by the monitor of the gaming station.

22. The gaming system of claim 21, wherein the broad perspective with which the public display monitor displays the at least a portion of the game comprises a perspective of a location of a spectator of the game.

23. The gaming system of claim 21, wherein the public display monitor displays only a portion of the game from the broad perspective, other portions of the game capable of being displayed by public display monitors or one or more adjacent gaming systems.

24. The gaming system of claim 19, wherein the compartment comprises a seat.

25. The gaming system of claim 24, wherein the compartment comprises a cockpit.

26. The gaming system of claim 24, wherein the wagering station is located behind the seat.
